(19) United States
(12) Patent Application Publication
(10) Pub. No.: US 2024/0112458 A1
(43) Pub. Date: Apr. 4, 2024

(54) RESTRICTIVE ENDORSEMENT DETECTION AND MERGER DURING UPLOAD PROCESS

(71) Applicant: Capital One Services, LLC, McLean, VA (US)

(72) Inventors: Karin GONZALEZ, Springfield, VA (US); Keegan FRANKLIN, Tucson, AZ (US)

(73) Assignee: Capital One Services, LLC, McLean, VA (US)

(21) Appl. No.: 18/141,771

(22) Filed: May 1, 2023

Related U.S. Application Data
(60) Provisional application No. 63/411,823, filed on Sep. 30, 2022.

(51) Int. Cl. G06V 10/94; G06V 10/26; G06V 30/226; G06V 30/262

(52) U.S. Cl. CPC G06V 10/95; G06V 10/26; G06V 10/945; G06V 30/226; G06V 30/274

(57) ABSTRACT

Systems for performing endorsement-based techniques on document during a document upload process are disclosed. During the document upload process, a document upload application may determine whether an endorsement is required on the document to be uploaded, the type of endorsement that is required, and whether the required endorsement is present on the document. Upon determining that an endorsement is required but is missing from the document, document upload application may retrieve and merge the required endorsement with the document as part of the document upload process.

### CROSS-REFERENCE TO RELATED APPLICATIONS

This application claims priority to U.S. Provisional Patent Application No. 63/411,823 (Attorney Docket No. 4375.2680000), filed Sep. 30, 2022, titled “Restrictive Endorsement Detection and Merger During Upload Process” the contents of which are hereby incorporated herein by reference in its entirety.

### TECHNICAL FIELD

Aspects relate to systems and methods for dynamically detecting and merging endorsements to a document image during an upload process.

### BACKGROUND

Currently, computer-based (e.g., laptop) or mobile-based (e.g., mobile device) technology allows a user to initiate a document upload process for uploading images or other electronic versions of a document to a backend system (e.g., a document processing system) for various purposes. In some cases, the backend system will require these documents to be endorsed, such as via a signature of the user. Current processes may require the user to manually endorse (e.g., sign) the document prior to initiating the document upload process because there currently does not exist a mechanism for electronically providing an endorsement during the upload process, especially a mechanism that complies with security requirements enforced by the backend system on uploaded documents.

### SUMMARY

Provided herein are system, method, and/or computer program product embodiments, and/or combinations and sub-combinations thereof for performing endorsement-based techniques on a document during a document upload process between a document upload application installed on user equipment and a backend system.

An example method embodiment may include steps during a document upload process including the document upload application receiving a front image of the document and a back image of the document. The document upload application may transmit the front image of the document and the back image of the document to a backend system. Steps for extracting information from the front image and back image may be performed to determine whether an endorsement of the document is required, whether such an endorsement is present on the document, and merging an endorsement with the document image(s) after determining that an endorsement is needed but is not present on the document. Steps for extracting may include extracting numerical text from a first predefined zone in the front image of the document and text associated with a user of the mobile device from a second predefined zone in the back image of the document. Extracting the text may be conditioned on whether the numerical text is above a particular threshold amount. A determination may be made whether the extracted text is empty (e.g., comprises a null value) in determining whether the endorsement is present on the document. If an endorsement is required but missing from the document, the document upload application may display a user prompt to populate a second predefined zone with the text associated with the user.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the pertinent art to make and use the disclosure.

FIG. 1 is an exemplary document upload environment for providing mid-stream adjustments to a document upload process according to aspects of the present disclosure.

FIG. 2 is an exemplary depiction of a document to be uploaded during a document upload process according to aspects of the present disclosure.

FIG. 3 is an example method of a document upload process for performing signature verification at a user equipment, according to aspects of the present disclosure.

FIG. 4 is an example method of a document upload process for performing signature verification at a backend system, according to aspects of the present disclosure.

FIGS. 5A-D are example depictions of user interfaces for receiving authorization to utilize digital endorsements, according to aspects of the present disclosure.

FIG. 6 is an example architecture of devices that can be used to implement the system according to aspects of the present disclosure.

In the drawings, like reference numbers generally indicate identical or similar elements. Additionally, generally, the leftmost digit(s) of a reference number identifies the drawing in which the reference number first appears.

### DETAILED DESCRIPTION

The following aspects are described in sufficient detail to enable those skilled in the art to make and use the disclosure. It is to be understood that other aspects are evident based on the present disclosure, and that system, process, or mechanical changes may be made without departing from the scope of an aspect of the present disclosure.

In the following description, numerous specific details are given to provide a thorough understanding of aspects. However, it will be apparent that aspects may be practiced without these specific details. To avoid obscuring an aspect, some well-known circuits, system configurations, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the system may be operated in any orientation.

Certain aspects have other steps or elements in addition to or in place of those mentioned. The steps or elements will become apparent to those skilled in the art from a reading of the following detailed description when taken with reference to the accompanying drawings.

### System Overview and Function

Provided herein are a method, a system, computer program product embodiments, and/or combinations and sub-combinations thereof for providing endorsement-based techniques, including endorsement requirement detection, endorsement detection, and endorsement merger, during a document upload process. The present disclosure distinguishes between endorsements and signatures. Endorsements may include signatures but also additional text, such as a predefined restrictive phrase, that defines or limits the purpose of the document, such as endorsing the check to an entity associated with a specific backend system, such as a bank and its backend system for processing the check. The present disclosure relates specifically to merging endorsements, not just signatures, with document images.

In some embodiments, the technology described herein provides a system that incorporates endorsement-based techniques within a document upload process between a document upload application installed on user equipment and a backend system. Endorsement requirement detection can refer to determining, based on content in the document, whether an endorsement is required on the document before it is uploaded to the backend system. Examples of content include any combination of user identification, a monetary amount, and account information. The results of the endorsement requirement detection may trigger endorsement detection for detecting the presence of the required endorsement on the document. And the results of the endorsement detection may then trigger endorsement merger for electronically merging a required endorsement with image data of a document to be uploaded, and transmitting the resulting merged endorsement-document image to the backend system to continue the upload process.

Examples of a document upload process include mobile deposit of negotiable instruments such as checks. A negotiable instrument includes a document that legally obligates one party to pay a specified sum of money to another party. A check may be presented from a first party to another party and represents an obligation from the first party to transfer of money to the second party. Depositing the check into an account at a financial institution of the second party requires the second party to endorse the check.

New technologies allow users who receive negotiable instruments to digitally deposit checks into accounts of financial institutions. Accounts may be any type of account for depositing funds, such as checking and savings. Users may endorse the check which may include either a signature only or a signature in addition to a predefined phrase that acts to restrict where the negotiable instrument may be deposited. As part of the mobile deposit, users may use a the camera of a mobile device to capture and transfer a digital image of a check or other negotiable instrument to a financial institution which processes the digital image. After processing, funds associated with the negotiable instrument in the digital image may be deposited in a user's bank account.

Endorsement of the negotiable instrument is an important part of the mobile deposit process. Different types of endorsement may be required by financial institutions based on different properties of the negotiable instrument, such as the monetary amount to be transferred into the account. For example, a simple endorsement such as only a signature may be required for instruments that are determined to be lower risk (e.g., monetary amount below a threshold) while a restrictive endorsement, such as a signature plus a predefined phrase that identifies the financial instrument, may be required for higher risk instruments (e.g., monetary amount above a threshold).

In some embodiments, endorsement requirement detection and endorsement detection utilize character recognition to detect content in the document image(s) to perform their respective detection functions. The endorsement requirement detection and endorsement detection performed may be initiated automatically without user input such as upon uploading a document or the backend system receiving one or more images of the document being uploaded. For example, the document upload application may receive one or more images from a camera integrated with or separate from the user equipment. The document upload application would then transmit the one or more images to the backend system. Accordingly, in some embodiments, some or all of the endorsement techniques may be performed solely by the document upload application, solely by the backend system, or distributed between both. In some embodiments, the endorsement requirement detection and endorsement detection may be performed upon receiving a user input, such as an instruction to proceed with the upload.

The technology described herein improves upon existing document upload processes by incorporating endorsement-based techniques for dynamically determining whether a endorsement is required on a document being uploaded and enabling the receipt of an electronic endorsement to be merged with the document image within the document upload process. This technology is advantageous to backend systems that process high-value documents, such as checks or other negotiable instruments, where endorsements on the document mitigate the risk of fraudulent activity that may occur with such high-value documents. Restrictive endorsements, which may include a predefined restrictive phrase, provide additional security over simple endorsements. Detection and merger of the predefined restrictive phrase on document images requires implementing additional OCR techniques either on user equipment, on backend systems, or a combination of both.

In embodiments where the document to be uploaded is a check, certain backend systems (maintained by banks) may implement a threshold amount, such as $5,000, on checks that will trigger a signature requirement on the check to be accepted in the document upload process. When such high-value documents are detected, the document upload process may initiate the endorsement merger for receiving the endorsement at the user equipment and merging the endorsement with the document image to form a merged document image with the restrictive endorsement. The merger may occur at the document upload application or at the backend system. The merger may require the endorsement to be placed at a predefined zone of the document.

In some embodiments, the backend system may require different types of endorsements such as a simple endorsement comprising only a signature or a restrictive endorsement that includes a signature along with a predefined restrictive phrase. The backend system may require the simple endorsement for a document that includes content below a threshold amount and the restrictive endorsement for a document that includes content above the threshold amount. The predefined restrictive phrase may specify the backend system to which the document is being uploaded which provides another layer of security to mitigate fraud risk by preventing the document from being uploaded or used at other backend systems.

In some embodiments, the endorsement merger may receive the digital endorsement via the document upload application and may either merge it with the document image as an overlay or merge it as a private key with the binary of the image (which is formed by transcoding the document image to a binary format). As an overlay, the endorsement may be visible in the appropriate location on the document in the merged document image. As part of the binary, the endorsement may be implemented as a private key that is incorporated into the binary of the image. The private key is not visible but is machine detectable as part of the document image data.

In an exemplary embodiment, the backend system may be configured to process certain types of documents such as checks or other financial instruments involving negotiable funds. Certain types of document, such as checks, may include predefined areas or zones where certain text should be input. For example, a document may have predefined zones for the numerical text, such as the check amount, for text describing the numerical text, and for endorsements. Documents may include any number of predefined zones and the backend system may be configured to extract information from those predefined zones.

The backend system may receive one or more images of the check being uploaded to a user account maintained by the backend system and that is associated with the document upload application. One or both of the document upload application and the backend system may include components for detecting content of the document during the document upload process, determining whether an endorsement is required on the document, determining the type of endorsement that is required, determining whether the required endorsement is already on the document, and merging the endorsement (if one is required and is missing from the document) with a document image to generate a merged image with the document and the endorsement. For example, the user account may be bank account (e.g., checking or savings) into which an amount specified by the check is to be deposited.

Therefore, the technology described herein solves one or more technical problems that exist in the realm of online computer systems and in particular, with document upload processes that do not assess the need for a endorsement on a document and provide the capability to merge a required endorsement with an image of the document to create a merged document image having the endorsement during the upload process. This prevents unnecessary steps to be taken by the document upload application, such as having to cancel the upload process (e.g., to allow for a manual endorsement to be added to the document). Prior upload processes lacking the technology disclosed herein, such as the technology to detect and then merge (if necessary) a endorsement, would simply outright prevent the upload of high-value documents or would allow such documents to be uploaded at the risk of potential fraudulent activity (if the check did not include a manual endorsement), exposing the backend system to potential losses and fraud. The technology described herein reduces that risk by improving the endorsement-based functions of the user equipment and the backend system.

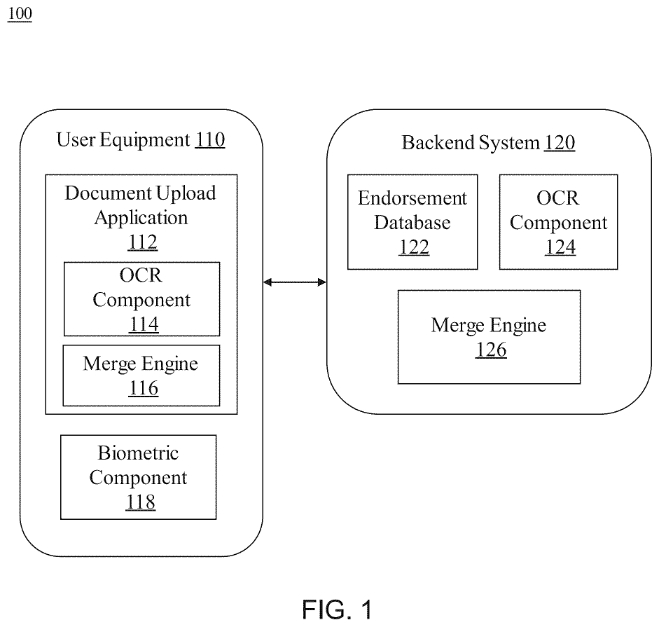

This problem is rooted in the typical functioning of prior art document upload applications and backend systems which lacked the functions for detecting contents of the document, determining whether a simple or restrictive endorsement is required on the document based on the detected contents, and merging the required endorsement with the document image to create a merged document image, all within the flow of a document upload process. The technology as described herein provides an improvement in the functioning of the document upload application and the backend system by adding additional endorsement-based capabilities to each. One or more solutions described herein are necessarily rooted in computer technology through the modification of communications between the document upload application and the backend system as well as of the document upload application itself. Moreover, the steps of these techniques are only capable of being performed by a user equipment (with the document upload application installed) or the backend system such as the character recognition process for identifying the contents of the document and performing the electronic merger of an electronic endorsement with an electronic document image. The technology described herein reduces or eliminates the problem of conventional document upload processes as will be described in the various embodiments of FIGS. 1-6.

Various embodiments of these features will now be discussed with respect to the corresponding figures.

FIG. 1 is an exemplary document upload environment 100 for performing endorsement-based techniques on a document to be uploaded during a document upload process, according to aspects of the present disclosure. In one example, environment 100 comprises user equipment 110 and backend system 120.

In an exemplary embodiment, user equipment 110 may be implemented as a mobile device such as a smartphone or a tablet. User equipment 110 may include a document upload application 112 that is configured to connect with backend system 120 and a biometric component 118 for receiving user input associated with endorsing the document. In some embodiments, document upload application 112 may include optical character recognition (OCR) component 114 and merge engine 116. In some embodiments, backend system 120 may include endorsement database 122, OCR component 124, and merge engine 126.

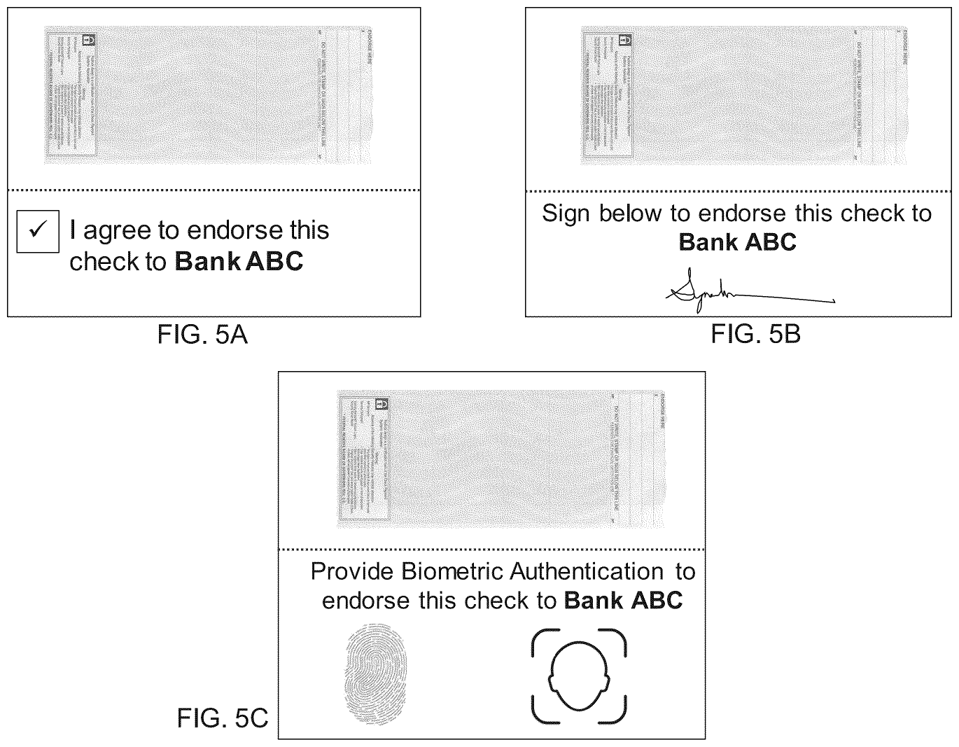

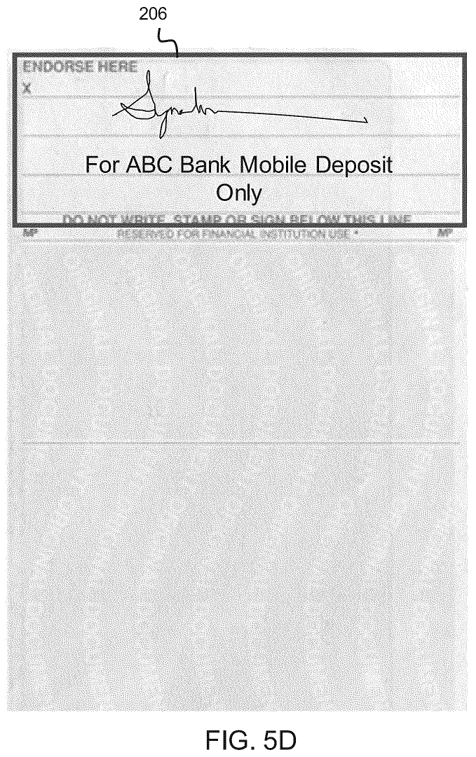

Document upload application 112 may be configured to display a graphical user interface on user equipment 110. The graphical user interface may provide options to receive images of documents being uploaded to backend system 120. Document upload application 112 may include a camera function that utilizes a camera (not shown) of user equipment 110 to capture one or more images of a document being uploaded to the backend system 120. When it is determined that an endorsement is required on the document, document upload application 112 may also control the graphical user interface to display a screen to receive the user input. The user input may include various interfaces or prompts for allowing the user to authorize the use of a digital endorsement for merger with the document image. Examples of these interfaces are shown in FIGS. 5A-C which are discussed further below.

If a simple endorsement is used, the user interface may provide a signature box to receive the user's physical signature (in the form of a finger pattern received on a touchscreen of user equipment 110). Document upload application 112 may store the received signature information in the form of a signature image which may be merged to the document image, such as in the form of an overlay.

If a restrictive endorsement is used, document upload application 112 may allow the user to provide authorization to use a pre-stored version of the signature and the predefined restrictive phrase, instead of requiring the user to manually input both via the touch screen. In some embodiments, document upload application 112 may require the user to provide physical signature via a touchscreen (as when using the simple endorsement) and then allow the user to provide authorization use a pre-stored version of the predefined restrictive phrase. The combination of the signature and the predefined restrictive phrase may then be merged with the document image at a predefined zone of the document. In order to obtain user authorization, document upload application 112 may provide various interfaces shown in FIGS. 5A-5C, which are discussed further below.

In some embodiments, document upload application 112 may perform one or more of the endorsement-based techniques. In such embodiments, document upload application 112 may include OCR component 114 and merge engine 116 which are configured to perform one or more of the endorsement requirement detection, endorsement detection, and endorsement merger. As part of endorsement requirement detection, OCR component 114 may detect content of the document including any amounts listed in the document. The content may be located at predefined zones of the document. For example, a check may include predefined zones for the amount of money to be deposited into a user account maintained by backend system 120.

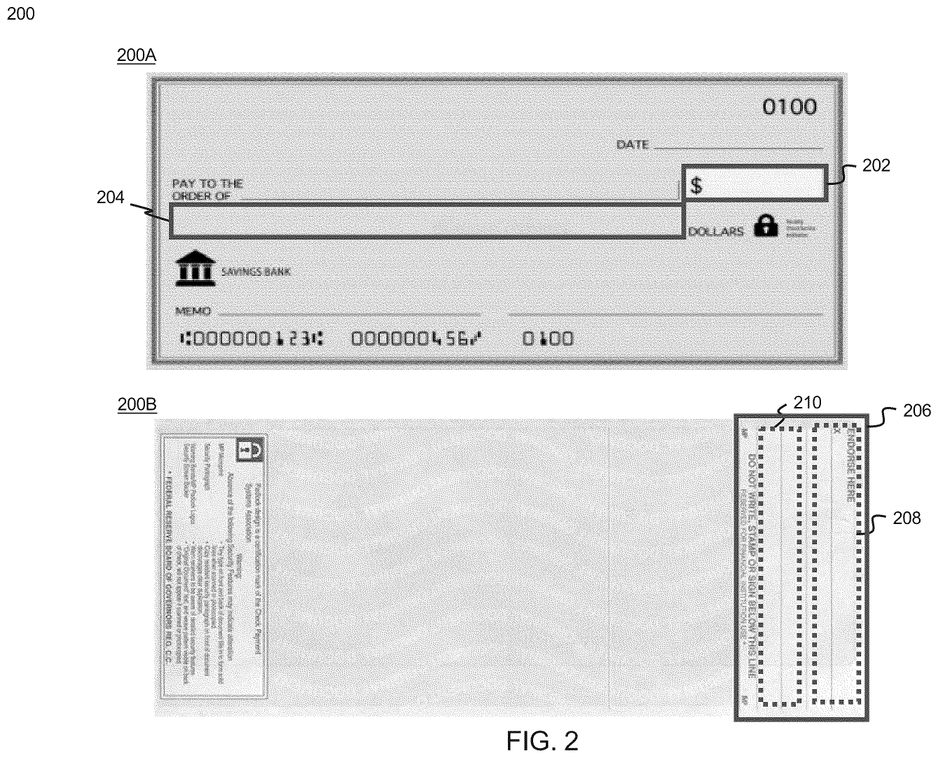

FIG. 2 is an exemplary document 200 to be uploaded during a document upload process according to aspects of the present disclosure. Document 200 may include a front 200A and a back 200B. Front 200A may include predefined amount zones 202 and 204 that specify the amount of funds to be deposited into a user account. Predefined amount zone 202 may specify the amount in a numerical format. Predefined amount zone 204 may specify the amount in a written format. Back 200B may include a predefined endorsement zone 206, with a signature zone 208 and a predefined restrictive zone 210 (if required), where the endorsement is required to be located, either physically on the paper or as an image, such as via an overlay on the document image. In some embodiments, predefined endorsement zone 206 may be left blank document if a digital endorsement is used to sign a binary version of the image. In some embodiments, backend system 120 may allow signature zone 208 to be left blank in lieu of using a private key with the binary of the image while predefined restrictive zone 210 may be populated with the predefined restrictive phrase.

Returning to FIG. 1, if endorsement detection is required based on the results of the endorsement requirement detection, OCR component 114 may further determine whether a physical endorsement (i.e., a endorsement on the check itself) is present on the document by performing OCR on the document image. For example, OCR component 114 may locate predefined endorsement zone 206 of document 200 and detect whether any endorsement data is present in the document image.

If OCR component 114 determines that an endorsement is required but is missing from the document, document upload application 112 may pass control over the document upload process to merge engine 116 which receives the document images. Merge engine 116 may be responsible for determining the endorsement (e.g., simple or restrictive) that is required, retrieves the required endorsement, and performs the endorsement merger of the endorsement and the document images.

In some embodiments, merge engine 116 may determine the type of endorsement that is required based on additional information received from OCR component 114. For example, OCR component 114 may provide the amount detected in performing OCR on the predefined amount zone 204 and/or predefined amount zone 206. Merge engine 116 may compare this amount with a threshold value which indicates the type of endorsement that is required for the document. For example, an amount below a threshold value may require only a simple endorsement while an amount that is above the threshold value may require a restrictive endorsement which includes both the signature and a predefined restrictive phrase. An example of a predefined restrictive phrase is “For ABC Bank Mobile Deposit Only” which indicates that the document is to be uploaded to a backend system 120 associated with ABC Bank. Merge engine 116 may then retrieve the required endorsement either in real-time, via the graphical user interface provided by document upload application 112, or a pre-stored version, which may be stored in a secure location in user equipment 110 or in backend system 120. If in real-time, merge engine 116 will receive the physical signature or endorsement provided via a touchscreen of user equipment 110. Retrieving the pre-stored endorsement may be based on interaction with biometric component 118.

Biometric component 118 may be implemented as any component that can receive biometric information from the user such as a fingerprint scanner and a camera configured to perform facial recognition. Biometric component 118 may be activated as needed by document upload application 112 during the upload process when it is determined that an endorsement of the document is needed to complete the process. Instead of requiring the user to provide a signature or endorsement via the touchscreen in the manner discussed above, document upload application 112 may utilize biometric component 118 to retrieve biometric information of the user in order to incorporate a pre-stored endorsement into either the document image or the binary of the image. For example, upon verifying biometric data from biometric component 118, document upload application 112 may retrieve a pre-stored endorsement from memory, of user equipment 110 or of backend system 120, and merge the pre-stored endorsement as an overlay onto the document image to create a merged document image that includes the pre-stored endorsement aligned in ab appropriate predefined zone of the document. As another example, document upload application 112 may retrieve a digital signature (e.g., such as private key) from memory, of user equipment 110 or of backend system 120, and merge the digital signature with the binary image data of the document image and merge the predefined restrictive phrase as an image overlay on the document image. Either approach may be triggered based on verification of the biometric information from biometric component.

After retrieving the required endorsement, merge engine 116 may then merge the endorsement with the document image. If a physical endorsement, (either in real-time or a pre-stored version), merge engine 116 may merge the endorsement as an overlay in the appropriate location of the document, such as predefined endorsement zone 206, in the document image. Document upload application 112 may display the merged document image with the endorsement on the graphical user interface. If a digital endorsement, merge engine 116 may merge the endorsement with a binary version of the image where the merged endorsement is not viewable on the graphical user interface but is machine readable by the backend system.

In some embodiments, document upload application 112 may initiate the endorsement-based techniques described above automatically upon receipt of the documents or upon receiving a user instruction to initiate the document upload process, such as receiving a slide-to-deposit instruction from the user to initiate a check deposit.

Backend system 120 may include an endorsement database 122. In some embodiments, endorsements including both signatures and the predefined restrictive statement may be pre-stored in endorsement database 122. In some embodiments, rather than requiring the user to manually input his signature and endorsement or even digitally via the graphical user interface provided by document upload application 112 (i.e., during the document upload process), backend system 120 may utilize pre-stored signatures and endorsements from endorsement database 122. For example, when an endorsement is required on a document, backend system 120 may retrieve the required endorsement from endorsement database 122. Retrieving the endorsement from endorsement database 122 may be conditioned based on biometric information received from biometric component 118. In some embodiments, backend system 120 may transmit the retrieved endorsement to document upload application 112 which may merge the endorsement with the document image, and which may display the merged image on a graphical user interface. Document upload application 112 may then transmit the merged image to backend system 120. In some embodiments, backend system 120 may perform the endorsement merger.

Document upload application 112 performing endorsement merger (either through receiving the physical image via the touchscreen of user equipment 110 or via a pre-stored endorsement received from backend system 120) provides certain advantages such as reducing the number of images being transmitted to backend system 120 and ensures that images received at the backend system 120 already includes the required endorsement with the document image. In such embodiments, document upload application 112 only needs to send the required amount of document images (e.g., front 200A and back 200B) to backend system 120 and no further processing is required by backend system 120.

Backend system 120 performing endorsement merger (either through receiving the physical image of the endorsement from the document upload application 112 or via the pre-stored endorsement retrieved from endorsement database 122) also provides advantages such as increased security because the merger process occurs at the backend system 120 rather than on a user equipment 110. In such embodiments, backend system 120 generates additional document images in addition to the document images (that do not include the required endorsement) received from document upload application 112. These additional document images are images that include the merged document image that include the required endorsement. Backend system 120 must ensure that the generated additional document images are linked to the document images received from document upload application 112. For example, backend system 120 may link the reference identifiers of the received document images to the reference identifier of the new merged document image. This additional step could increase latency of the document upload process with the benefit of providing the backend system more control over the endorsement merger. This issue is avoided when document upload process performs the endorsement merger because only the required document images, that already include the endorsement, are transmitted to the backend system 120.

In some embodiments, the backend system 120 may be implemented as one or more servers. Backend system 120 may be implemented as a variety of centralized or decentralized computing devices. For example, backend system 120 may be a mobile device, a laptop computer, a desktop computer, grid-computing resources, a virtualized computing resource, cloud computing resources, peer-to-peer distributed computing devices, a server farm, or a combination thereof. Backend system 120 may be centralized in a single device, distributed across multiple devices within a cloud network, distributed across different geographic locations, or embedded within a network. Components of backend system 120, such as endorsement database 122, OCR component 124, and merge engine 126 may be implemented within the same device (such as when backend system 120 is implemented as a single device) or as separate devices (such as when backend system 120 is implemented as a distributed system with components connected via a network).

In some embodiments, backend system 120 may perform one or more of the endorsement-based techniques in coordination with or independently of document upload application 112. In such embodiments, backend system 120 may include OCR component 124 and merge engine 126 which are configured to perform one or more of the endorsement requirement detection, endorsement detection, and endorsement merger. In some embodiments, document upload application 112 may perform all steps of endorsement requirement detection, endorsement detection, and endorsement merger. In some embodiments, backend system 120 may perform all the steps. In some embodiments, document upload application 112 and backend system 120 may employ a hybrid approach where document upload application 112 performs some of the steps and backend system 120 performs the other steps.

OCR component 124 may be implemented in a similar manner as OCR component 114. Merge engine 126 may be implemented in a similar manner as merge engine 126. As noted above, implementing these components on backend system 120 may increase the security of the document upload process at the cost of increased latency in processing the document images.

In some embodiments, backend system 120 is configured to perform all steps of endorsement requirement detection, endorsement detection, and endorsement merger. OCR component 124 receives document images from user equipment 110. OCR component 124 may then detect content of the document images including any amounts listed in the document by identifying content located at predefined zones of the document and the presence of an endorsement (if needed, based on the detected amount of the document). If an endorsement is required but is not present on the document (as determined from the document images), OCR component 124 passes the document images to merge engine 126 which may determine the type of endorsement that is required based on the information received from OCR component 124. For example, OCR component 124 may provide the amount detected in performing OCR on the predefined amount zone 204 and/or predefined amount zone 206. Merge engine 126 may then determine the type of endorsement that is needed in a similar manner discussed above with for merge engine 116. Merge engine 126 may retrieve the required endorsement. If a real-time endorsement is required, merge engine 126 may transmit a signal to document upload application 112 to display, via the graphical user interface, an interface for receiving the endorsement via interaction with the touchscreen of the user equipment. In other embodiments, merge engine 126 may retrieve a pre-stored version of the required endorsement from a memory of backend system 120. Retrieving the pre-stored endorsement may be based on merge engine 126 transmitting a signal to biometric component 118 which would operate in a similar manner described above to receive biometric information to authorize the use of the pre-stored endorsement.

After retrieving the required endorsement, merge engine 126 may then merge the endorsement with the document image. If a physical endorsement, (either in real-time or a pre-stored version), merge engine 126 may merge the endorsement as an overlay in the appropriate location of the document, such as predefined endorsement zone 206, in the document image. If a digital endorsement (e.g., using a private key in lieu of a signature and predefined restrictive phrase), merge engine 126 may merge the endorsement with a binary version of the image.

In some embodiments, various step of endorsement requirement detection, endorsement detection, and endorsement merger are distributed between document upload application 112 and backend system 120, document upload application 112 may perform the steps of endorsement requirement detection and endorsement detection while backend system 120 performs the steps of endorsement merger. For example, document upload application 112 may determine whether an endorsement is required for the document and if so, whether the required endorsement is present on the document. If a required endorsement is not present, document upload application 112 may transmit the document images and an indication of the endorsement that is required for the document to backend system 120 which may then perform endorsement merger based on the received information.

The components described in FIG. 1 may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the environment 100 or installed as a removable portion of the environment 100.

Environment 100 can be used in a variety of areas implementing document upload techniques. These include financial applications, security applications, etc. where documents being uploaded into user accounts may be subject to fraudulent activity. For example, when processing important document such as driver's licenses, checks, financial documents, etc. The environment 100 allows for dynamic endorsement-based techniques to be utilized during a document upload process and requires image processing steps that cannot be practicably performed in the human mind.

### Methods of Operation

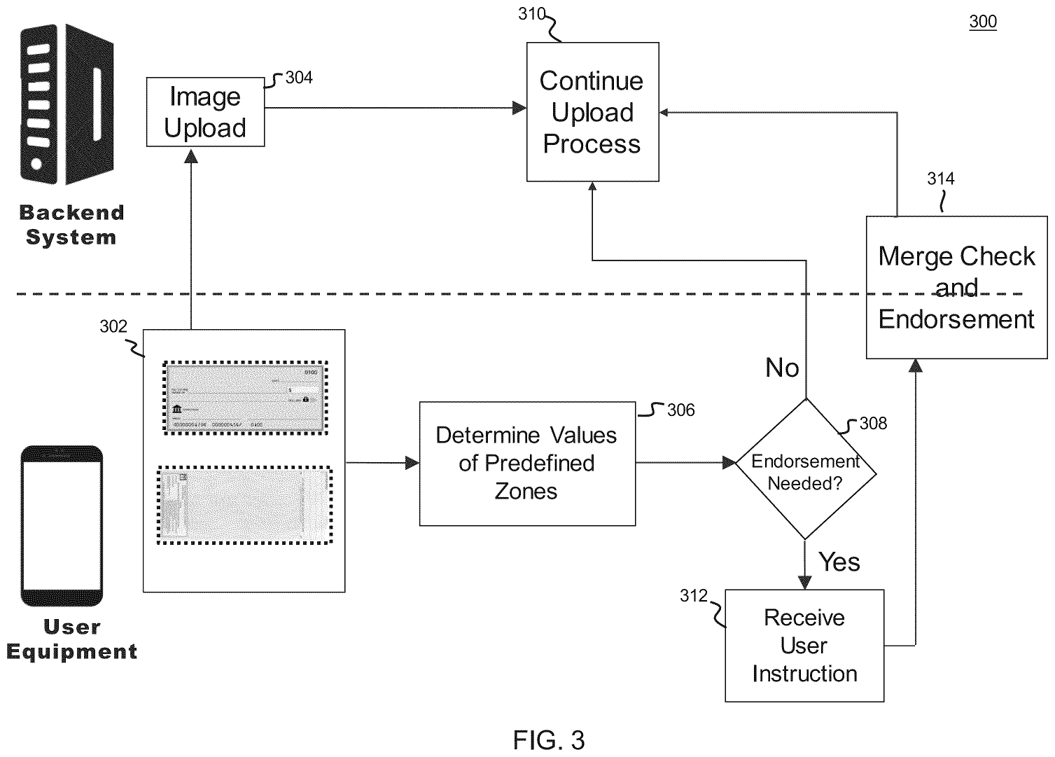

FIG. 3 is an example method 300 of operating the environment 100 to perform endorsement-based techniques of document images being uploaded to a user account maintained by backend system 120, according to aspects of the present disclosure. As a non-limiting example with regards to FIG. 1, one or more processes described with respect to FIG. 3 may be performed by one or more devices of environment 100. In such an embodiment, the one or more devices of environment 100 may execute code in memory to perform certain steps of method 300. While method 300 of FIG. 3 will be discussed below as being performed by one or more components of environment 100, other devices not shown may store the code and therefore may execute method 300 by directly executing the code. Accordingly, the following discussion of method 300 will refer to devices of FIG. 1 as an exemplary non-limiting embodiment of method 300. Moreover, method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art(s).

At step 302, document upload application 112 installed in user equipment 110 receives image data of a document being uploaded to backend system 120, such as by controlling a camera on user equipment 110. The image data represents a number of images of the document that are needed by backend system to complete the document upload process. In some embodiments, the image data may include a front and back capture of a single page document, such as the front and back of a check. In some embodiments, the image data may include multiple images of the pages of a multi-page document or different documents being uploaded together. In some embodiments, document upload application 112 may be configured with a parameter indicating the number of document images to be captured of the document being uploaded. For example, the graphical user interface provided by document upload application 112 may be configured to require capturing both a front image of the document and a second image of the document based on the number of images that are needed by backend system 120 to upload the document.

At step 304, document upload application 112 transmits the image data to backend system 120, which may cache the received images in a temporary location in backend system 120 such as an S3 bucket implemented with a cache control. In some embodiments, the image data includes a front image of the document and a back image of the document.

Document upload application 112 may perform endorsement requirement detection, endorsement detection, and endorsement merger at steps 306-312.

At step 306, document upload application 112 may determine values of predefined zones in the document from the document images. OCR component 114 may utilize optical character recognition (OCR) to determine the values from the document images. In some embodiments, document upload application 112 may be configured to process a specific type of document, such as a check, and performs OCR on one or more predefined zones of that type of document, such as predefined amount zones 204 and 206 and predefined endorsement zone 208. For example, OCR component 114 may determine a value of the deposit amount from one or both of predefined amount zones 204 and 206 and may determine whether an endorsement is present on the document. In some embodiments, document upload application 112 may perform OCR automatically upon capturing document images in step 302. In some embodiments, document upload application 112 waits for a user instruction, such as an instruction to proceed with the document upload process, before performing OCR.

At step 308, document upload application 112 may determine whether an endorsement is needed based on the values of the predefined zones determined at step 306. This determination may be based on one or more validation rules from backend system 120. A validation rule may define any validation requirement for documents to be uploaded to backend system 120 such as when a simple endorsement is required or when a restrictive endorsement is required. For example, a validation rule may specify a threshold value for any amount located in a predefined zone of the document and if the amount if greater than that value, one of the endorsements is required. For example, the validation zone may require the extracted endorsement text in the predefined endorsement to be a non-null value.

The document may include a predefined zone on the front of a document for numerical text, such as check amount. OCR component 114 may extract, from the predefined zone, a numerical text. The extracted value may be compared with a threshold amount (e.g., a setting established by backend system 120) to determine whether backend system 120 requires an endorsement on the document based on the extracted value. If an endorsement is required, OCR component 114 may further determine the type of endorsement that is required. For example, OCR component 114 may compare the amount extracted from predefined zones with different threshold values each of which correspond to a different type of endorsement. For example, a first threshold value may indicate a simple endorsement (e.g., just a signature) is required on the document while a second threshold value may indicate a restrictive endorsement (e.g., a signature in combination with a predefined restrictive phrase) is required. Backend system 120 may establish the threshold values and the corresponding mapping to the different type of endorsement in a secure memory of user equipment 110 that is only accessible to document upload application 112.

After determining that an endorsement is required (e.g., the numerical text extracted from a predefined zone of the front image of the document exceeds a threshold value) and the type of endorsement that is required, OCR component 114 may next perform endorsement detection to determine whether the endorsement is present on the document being uploaded. In some embodiments, OCR component 114 may perform OCR on a predefined endorsement zone of the document image (e.g., predefined endorsement zone 208 from document 200) to determine whether the required endorsement is present in the image data. Predefined endorsement zone 208 may include expected endorsement text comprising text associated with a user of the mobile device, such as a signature, and text associated with the backend system, such as the predefined restrictive phrase that identifies the backend system.

For example, OCR component 114 may extract any text from a predefined zone of a back image of the document. In some embodiments, the text is associated with a user of the mobile device, such as the signature of the user. OCR component 114 may determine whether the required endorsement is on the document based on the extracted text. For example, if the extracted endorsement text is null (or comprises a null value which indicates that the predefined zone is blank), OCR component 114 may determine that the required endorsement (or any endorsement) is on the document. In some embodiments, if the extracted endorsement text is not empty, OCR component 114 may determine whether the extracted endorsement text matches the required endorsement. For example, if a simple endorsement is required, OCR component 114 will retrieve the simple endorsement from a memory and compare the extracted endorsement text with the retrieved endorsement to determine whether there is a match. If a restrictive endorsement is required, OCR component 114 will perform the same comparison and matching but between the extracted data and the stored restrictive endorsement.

At step 310, if document upload application 112 determines that an endorsement is not required on the document, it permits the upload process to continue which may include proceeding with uploading the document to backend system 120 which may perform any other additional processing of the document to complete the upload process.

At step 312, if document upload application 112 determines that an endorsement is required and that the extracted text is null based on the analysis of the image data of the document at step 308, document upload application 112 proceeds with a first step of endorsement merger to receive an user input for the endorsement. Merge engine 116 may determine whether a real-time endorsement or a pre-stored endorsement may be used. This determination may be based on a setting retrieved from a memory of user equipment 110 and may be set by a user or backend system 120. If merge engine 116 determines that a real-time endorsement is to be used, it may display a user prompt, such as a signature box for receiving an endorsement or a request for biometric authentication for retrieving a pre-stored endorsement, on the touchscreen of user equipment 110. For example, FIG. 5B depicts an interface that allows the user to input a signature.

If merge engine 116 determines that a pre-stored endorsement is to be used, it may submit a request after receiving permission from the user such as via a check-box, as depicted in FIG. 5A, from a signature via a signature block, as depicted in FIG. 5B, or via biometric information, such as via fingerprint or facial recognition, as depicted in FIG. 5C. Biometric information may be received from biometric component 118 which may be implemented as one or more of a fingerprint reader or facial recognition software that utilizes a camera of user equipment 110. The request may include user identification associated with the document upload application 112 and the type of endorsement needed for the document, for the endorsement from backend system 120.

The interfaces, or user prompts, of FIGS. 5A-C may be displayed by the document upload application 112 and enable the user to provide inputs for populating the predefined endorsement zone with one or both of the user's signature or the predefined restrictive phrase. Validation rules from backend system 120 may define which interfaces are displayed. For example the validation rule may specify displaying an interface (e.g., FIG. A, B or C) in the absence of expected endorsement text in the predefined endorsement zone 208 (i.e., the expected endorsement text comprises a null value).

In some embodiments, the request may be triggered by user input such as biometric input received via biometric component 118. Backend system 120 identify the pre-stored endorsement in endorsement database 122 based on information in the request. In some embodiments, the pre-stored endorsement may be an endorsement image to be used as an overlay over a predefined endorsement zone of a document as depicted in FIG. 5D which shows a signature and predefined restrictive phrase in predefined endorsement zone 206 of document 200.

In some embodiments, the pre-stored endorsement may be a digital signature, such as a private key, that is applied to the binary format of the image. In some embodiments, backend system 120 may transmit the pre-stored endorsement back to document upload application 112 for performing the endorsement merger at merge engine 116. In some embodiments, backend system 120 may perform the endorsement merger by receiving the document images from document upload application 112 and performing the merger using merge engine 126. After retrieving the required endorsement, backend system 120 may transmit a signal to document upload application 112 to transmit the document images to backend system 120.

Step 314 may be performed by document upload application 112 or by backend system 120. In some embodiments, merge engine 116 merges the document image with the required endorsement (either one received via the touchscreen of user equipment 110 or from backend system 120). In some embodiments, the merged image may include an overlay of the endorsement over a predefined endorsement zone of the document. In some embodiments, the merged image is a digital signature (such as a private key) applied to a binary format of the image. In some embodiments, backend system 120 merges the document image received from document upload application 112 with the endorsement (either one transmitted from user equipment 110 or retrieved from endorsement database 122 of backend system 120).

In some embodiments, backend system 120 may determine whether to perform the endorsement merger at the document upload application 112 or at backend system 120. For example, backend system 120 may determine that certain documents (e.g., those with amounts greater than a threshold) may warrant higher security and that the endorsement merger should take place at the backend system.

After endorsement merger is completed, by either document upload application 112 or backend system 120, the document upload process may continue with the merged image at step 310.

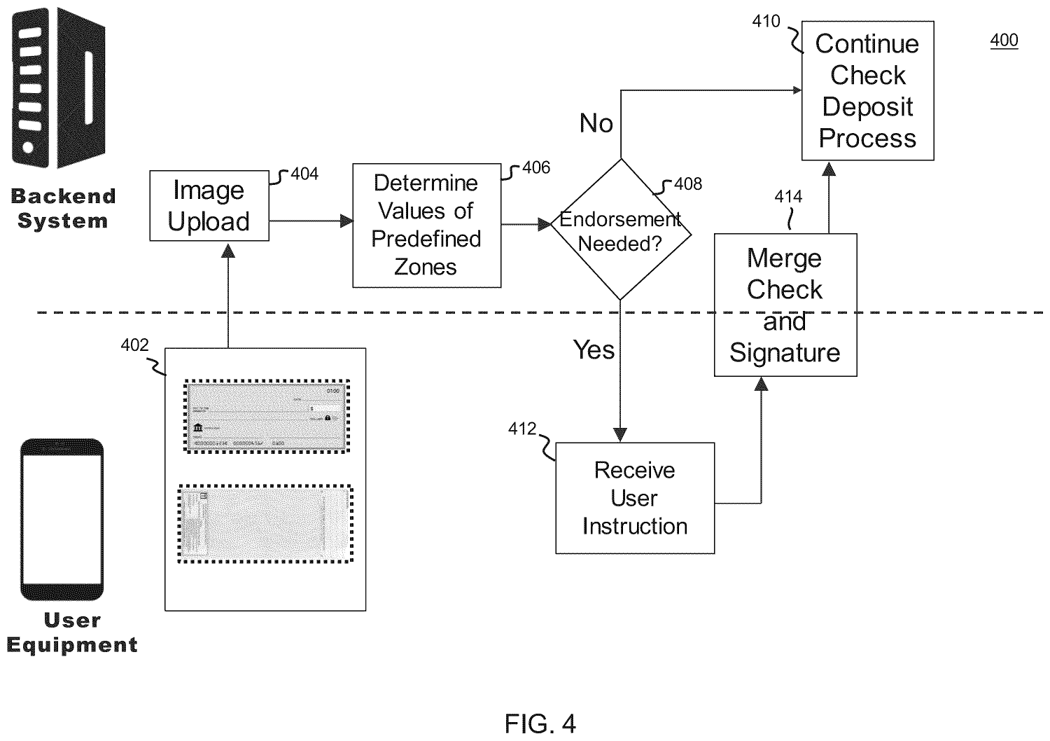

FIG. 4 is an example method 400 of operating the environment 100 to perform endorsement-based techniques of document images being uploaded to a user account maintained by backend system 120, according to aspects of the present disclosure. As a non-limiting example with regards to FIG. 1, one or more processes described with respect to FIG. 2 may be performed by one or more devices of environment 100. In such an embodiment, the one or more devices of environment 100 may execute code in memory to perform certain steps of method 400. While method 400 of FIG. 4 will be discussed below as being performed by one or more components of environment 100, other devices not shown may store the code and therefore may execute method 400 by directly executing the code. Accordingly, the following discussion of method 400 will refer to devices of FIG. 1 as an exemplary non-limiting embodiment of method 400. Moreover, method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art(s).

At step 402, document upload application 112 receives image data of a document being uploaded to backend system 120 in a similar manner described with respect to step 302 of FIG. 3.

At step 404, document upload application 112 transmits the image data to backend system 120, which may cache the received images in a temporary location in backend system 120 such as an S3 bucket implemented with a cache control.

At step 406, backend system 120 may determine values of predefined zones in the document from the document images. OCR component 124 may utilize optical character recognition (OCR) to determine the values from the document images received from document upload application 112. In some embodiments, backend system 120 may be configured to accept specific types of document, such as a check, and performs OCR on one or more predefined zones of that type of document, such as predefined amount zones 204 and 206 and predefined endorsement zone 208. For example, OCR component 124 may determine a value of the deposit amount and whether an endorsement is present on the document in the same manner discussed above with respect to OCR component 114. In some embodiments, OCR component 124 may perform OCR automatically upon receiving the document images in step 302. In some embodiments, OCR component waits to receive a user instruction, such as an instruction to proceed with the document upload process, from document upload application 112 before performing OCR.

At step 408, backend system 120 may determine whether an endorsement is needed based on the values of the predefined zones determined at step 406. OCR component 124 may extract, from the predefined zone, a numerical text and process the numerical text in the same manner discussed above with respect to OCR component 114. OCR component 124 may compare the extracted value may be compared with a threshold amount (e.g., a global setting that is applicable to documents supported by backend system 120) to determine whether an endorsement on the document is required based on the extracted value. OCR component 124 may further determine the type of endorsement that is required.

At step 410, if backend system 120 determines that an endorsement is not required on the document, it permits the upload process to continue which may include proceeding with processing of the uploaded document images.

At step 412, if backend system 120 determines that an endorsement is required and that the extracted text is null based on the analysis of the image data of the document at step 408, backend system 120 may transmit a signal to document upload application 112 to receive a user input for the endorsement. Merge engine 126 may determine whether a real-time endorsement or a pre-stored endorsement may be used which defines the type of user input that is required. If a real-time endorsement is to be used, document upload application 112 may display a user prompt, such as a signature box for receiving a signature or a request for biometric authentication for retrieving a pre-stored endorsement, on the touchscreen of user equipment 110. If a pre-stored endorsement is to be used, the document upload application may request user authentication, such as a password or biometric information, in order to retrieve the pre-stored endorsement from endorsement database 122.

Step 414, which merges the retrieved endorsement with the document image, may be performed by document upload application 112 or by backend system 120 and may be implemented in the same way discussed with respect to step 314.

After endorsement merger is completed, the document upload process may continue with the merged image at step 410.

### Components of the System

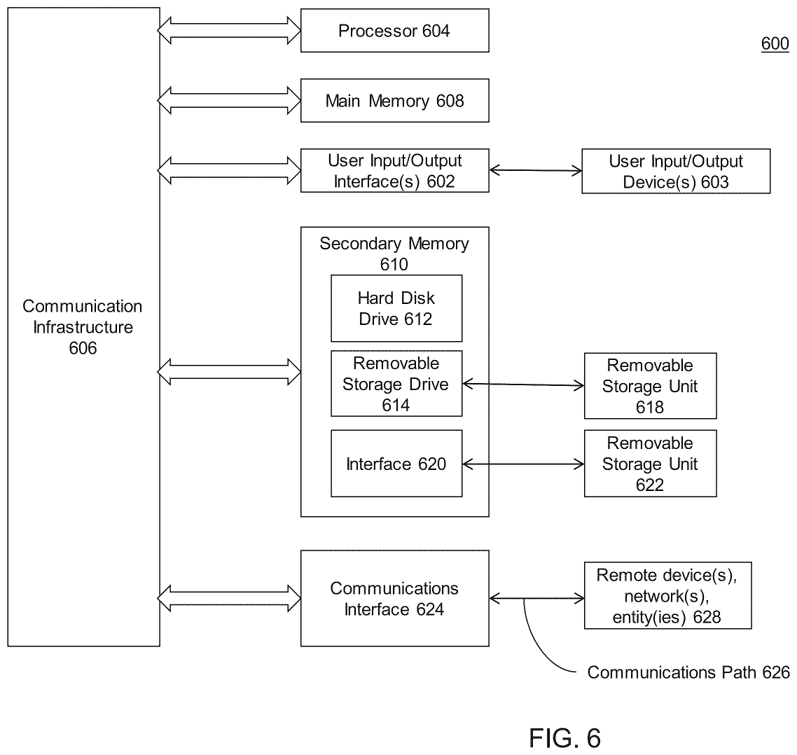

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The terms “module” or “unit” referred to in this disclosure can include software, hardware, or a combination thereof in an aspect of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

The above detailed description and aspects of the disclosed environment 100 are not intended to be exhaustive or to limit the disclosed environment 100 to the precise form disclosed above. While specific examples for environment 100 are described above for illustrative purposes, various equivalent modifications are possible within the scope of the disclosed environment 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

These and other valuable aspects of the aspects of the present disclosure consequently further the state of the technology to at least the next level. While the disclosed aspects have been described as the best mode of implementing environment 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computer-implemented method for endorsing a document during a document upload process, the method comprising:
receiving, by an document upload application on a mobile device, a front image of the document and a back image of the document;
transmitting, by the mobile device to a backend system, the front image of the document and the back image of the document, wherein the back image of the document comprises a predefined endorsement zone including a first predefined zone and a second predefined zone;
extracting, from the predefined endorsement zone, expected endorsement text comprising text associated with a user of the mobile device and text associated with the backend system, wherein the text associated with the user of the mobile device is extracted from the first predefined zone and the text associated with the backend system is extracted from the second predefined zone;
detecting that the expected endorsement text comprises a null value; and
displaying, by the document upload application on the mobile device and based on the expected endorsement text comprising the null value and a validation rule, a user prompt to populate the predefined endorsement zone with at least one of the text associated with the user or the text associated with the backend system.

2. The computer-implemented method of claim 1, wherein the validation rule defines a validation requirement requiring at least one of the text associated with the user of the mobile device or the text associated with the backend system may comprise a non-null value.

3. The computer-implemented method of claim 2, wherein the validation rule further defines a threshold value, the method further comprising:
extracting, from the first predefined zone in the front image of the document, a numerical text, wherein the validation requirement requires the non-null value for the endorsement text when the numerical text is greater than the threshold value.

4. The computer-implemented method of claim 1, wherein the text associated with the user comprises a signature and the text associated with the backend system is a predefined phrase.

5. The computer-implemented method of claim 1, wherein the front image comprises a second predefined endorsement zone, the method further comprising:
extracting, from the second predefined endorsement zone, a numerical text, wherein the expected endorsement text is extracted from the predefined endorsement zone responsive to the numerical text greater than a threshold value.

6. The computer-implemented method of claim 5, wherein the second predefined endorsement zone is associated with a monetary amount and the threshold value is a numerical amount retrieved from the backend system.

7. The computer-implemented method of claim 1, further comprising:
receiving, based on the user prompt, an instruction to populate the predefined endorsement zone with at least one of the text associated with the user or the text associated with the backend system; and
merging at least one of the text associated with the user or the text associated with the backend system with the back image of the document to create a merged back image.

8. The computer-implemented of claim 7, further comprising:
transmitting, from the mobile device to the backend system, the merged back image.

9. The computer-implemented method of claim 7, wherein the instruction indicates that at least one of the text associated with the user is and the text associated with the backend system is to be received via the mobile device, the method further comprising:
receiving, from a touchscreen display of the mobile device, at least one of the text associated with the user is and the text associated with the backend system is to be received via the mobile device.

10. A mobile device for endorsing a document during a document upload process, the mobile device comprising:
a memory;
at least one processor coupled to the memory and configured to:
receive, by an document upload application on a mobile device, a front image of the document and a back image of the document;
transmit, by the mobile device to a backend system, the front image of the document and the back image of the document, wherein the back image of the document comprises a predefined endorsement zone including a first predefined zone and a second predefined zone;
extract, from the predefined endorsement zone, expected endorsement text comprising text associated with a user of the mobile device and text associated with the backend system, wherein the text associated with the user of the mobile device is extracted from the first predefined zone and the text associated with the backend system is extracted from the second predefined zone;
detect that the expected endorsement text comprises a null value; and
display, by the document upload application on the mobile device and based on the expected endorsement text comprising the null value and a validation rule, a user prompt to populate the predefined endorsement zone with at least one of the text associated with the user or the text associated with the backend system.

11. The mobile device of claim 10, wherein the validation rule defines a validation requirement requiring at least one of the text associated with the user of the mobile device or the text associated with the backend system may comprise a non-null value.

12. The mobile device of claim 11, wherein the validation rule further defines a threshold value, the processor further configured to:
extract, from the first predefined zone in the front image of the document, a numerical text, wherein the validation requirement requires the non-null value for the endorsement text when the numerical text is greater than the threshold value.

13. The mobile device of claim 10, wherein the text associated with the user comprises a signature and the text associated with the backend system is a predefined phrase.

14. The mobile device of claim 10, wherein the front image comprises a second predefined endorsement zone, the processor further configured to:
extract, from the second predefined endorsement zone, a numerical text, wherein the expected endorsement text is extracted from the predefined endorsement zone responsive to the numerical text exceeding a threshold value.

15. The computer-implemented method of claim 14, wherein the second predefined endorsement zone is associated with a monetary amount and the threshold value is a numerical amount retrieved from the backend system.

16. The computer-implemented method of claim 10, the processor further configured to:
receive, based on the user prompt, an instruction to populate the predefined endorsement zone with at least one of the text associated with the user or the text associated with the backend system; and
merge at least one of the text associated with the user or the text associated with the backend system with the back image of the document to create a merged back image.

17. A non-transitory computer-readable medium storing instructions, the instructions, when executed by a processor on a mobile device for validating a document during a document upload process, cause the processor to perform operations comprising:
receiving, by an document upload application on a mobile device, a front image of the document and a back image of the document;
transmitting, by the mobile device to a backend system, the front image of the document and the back image of the document, wherein the back image of the document comprises a predefined endorsement zone including a first predefined zone and a second predefined zone;
extracting, from the predefined endorsement zone, expected endorsement text comprising text associated with a user of the mobile device and text associated with the backend system, wherein the text associated with the user of the mobile device is extracted from the first predefined zone and the text associated with the backend system is extracted from the second predefined zone;
detecting that the expected endorsement text comprises a null value; and
displaying, by the document upload application on the mobile device and based on the expected endorsement text comprising the null value and a validation rule, a user prompt to populate the predefined endorsement zone with at least one of the text associated with the user or the text associated with the backend system.

18. The non-transitory computer-readable medium of claim 17, wherein the validation rule defines a validation requirement requiring at least one of the text associated with the user of the mobile device or the text associated with the backend system may comprise a non-null value.

19. The non-transitory computer-readable medium of claim 18, wherein the validation rule further defines a threshold value, the operations further comprising:
extracting, from the first predefined zone in the front image of the document, a numerical text, wherein the validation requirement requires the non-null value for the endorsement text when the numerical text is greater than the threshold value.

20. The non-transitory computer-readable medium of claim 17, wherein the text associated with the user comprises a signature and the text associated with the backend system is a predefined phrase.
